(19) United States
(12) Patent Application Publication
(10) Pub. No.: US 2025/0356124 A1
(43) Pub. Date: Nov. 20, 2025

(54) MACHINE LEARNING MODEL WITH INPUT TOKEN SKIPPING AND INSERTION

(71) Applicant: Microsoft Technology Licensing, LLC, Redmond, WA (US)

(72) Inventors: Eric Joel HORVITZ, Portola Valley, CA (US); Harsha Prasad NORI, Seattle, WA (US)

(73) Assignee: Microsoft Technology Licensing, LLC, Redmond, WA (US)

(21) Appl. No.: 18/965,985

(22) Filed: Dec. 2, 2024

Related U.S. Application Data
(60) Provisional application No. 63/649,906, filed on May 20, 2024.

(51) Int. Cl. G06F 40/284; G06F 40/40

(52) U.S. Cl. CPC G06F 40/284; G06F 40/40

(57) ABSTRACT

A computing system is provided that instantiates a trained machine learning model and a model plugin. During inference, the model plugin receives an input sequence of input tokens of a prompt including context and a structured output definition. When the model plugin identifies deterministic input tokens corresponding to the structured output definition, it skips transmission of the deterministic input tokens to the machine learning model, and writes the one or more deterministic input tokens as deterministic output tokens to an output token sequence. The model plugin further passes a remainder of input tokens in the input sequence to the machine learning model. The machine learning model performs probabilistic token-wise generation of other output tokens in the output sequence based on the remainder of the input tokens, and outputs the output sequence including the deterministic output tokens and the other output tokens generated by the probabilistic token-wise generation.

### CROSS REFERENCE TO RELATED APPLICATIONS

This application claims priority to U.S. Provisional Patent Application Ser. No. 63/649,906, filed May 20, 2024, the entirety of which is hereby incorporated herein by reference for all purposes.

### BACKGROUND

In recent years, generative machine learning models have achieved impressive results. These models have been applied to generative tasks in such diverse fields as natural language generation, computational chemistry, image and video generation, and generation of computer code. The size of these models has grown with progress in the development of model architectures and increasing availability of specialized processors that speed up computation. The largest language models have recently exceeded several billion parameters. Large models such as these have the ability to produce output that closely resembles human output and scores high on accuracy benchmarks, albeit with significant consumption of compute resources. As these models continue to be developed, opportunities exist to improve their efficiency and accuracy, as discussed below.

### SUMMARY

A computing system is provided that instantiates a trained machine learning model and a model plugin. During inference, the model plugin receives an input sequence of input tokens of a prompt, the prompt including context and a structured output definition. The model plugin identifies one or more deterministic input tokens corresponding to the structured output definition. In response to identifying the one or more deterministic input tokens, the model plugin skips transmission of the one or more deterministic input tokens to the machine learning model, and writes the one or more deterministic input tokens as one or more deterministic output tokens to an output token sequence. The model plugin further passes a remainder of input tokens in the input sequence other than the one or more deterministic input tokens to the machine learning model. The machine learning model performs probabilistic token-wise generation of other output tokens in the output sequence based on the remainder of the input tokens without the one or more deterministic input tokens, and outputs the output sequence including the deterministic output tokens and the other output tokens generated by the probabilistic token-wise generation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system that implements a machine learning model configured to perform token skipping and insertion during inference, according to one example configuration of the present disclosure.

FIG. 2 shows a schematic view of the computing system of FIG. 1, parsing a structured output definition and displaying deterministically generated text and probabilistically generated text in a visually distinguishable manner in a response.

FIG. 3 shows a schematic view of the structured output definition of the computing system of FIG. 1.

FIG. 4 shows a schematic view of another example of a structured output definition that can be used by the computing system of FIG. 1.

FIG. 5 is a flowchart of a computerized method for implementing a machine learning model that performs token skipping and insertion during inference, according to one example implementation of the present disclosure.

FIG. 6 shows a schematic view of an example computing environment in which the computing system of FIG. 1 may be enacted.

### DETAILED DESCRIPTION

As discussed above, state-of-the-art transformer-based language models have recently eclipsed several billion parameters in size. While these models have produced useful results that resemble human generated content in many respects, these models still suffer from drawbacks in cost and accuracy. Regarding cost, these models consume significant time, energy, and compute resources to operate, particularly for larger models. Regarding accuracy, these models are inherently probabilistic by nature, being trained on next word prediction, and thus their outputs can vary in form and content. This can limit their potential application in situations calling for strictly formatted output.

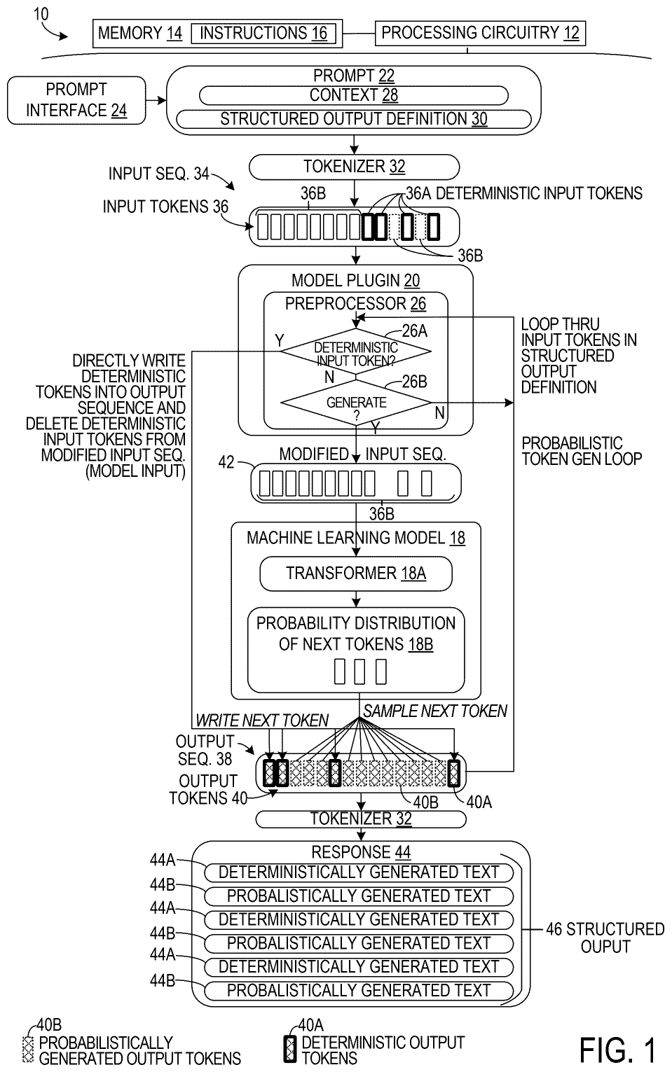

To address the above discussed issues, a computing system 10 is provided, as shown in FIG. 1. Computing system 10 includes processing circuitry 12 and associated memory 14 storing instructions 16 that when executed cause the processing circuitry 12 to perform the following functions. The processing circuitry 12 is configured to instantiate a trained machine learning model 18, and to instantiate a model plugin 20. The model plug-in 20 is configured to provide an interface to the machine learning model 18, to enable user-defined functionality to be implemented at the machine learning model 18. The model plugin 20 can be provided as an additional piece of software that is installed in an existing machine learning model 18, or can be incorporated into machine learning model 18 as a native interface. The machine learning model 18 can be a generative transformer-based model including an encoder-decoder architecture, decoder-only architecture, or encoder-only architecture. The transformer-based machine learning model 18 can be single mode or multi-modal. The inputs in a single mode or multi-modal configuration may include natural language input, image input, video input, audio waveform input, and/or parameterized data input from a data feed, as some examples. The machine learning model 18 can be a generative large language model having billions of parameters, such as GPT-3.5, GPT-40, BERT, ORCA-2, or LLaMA-2, as some specific examples.

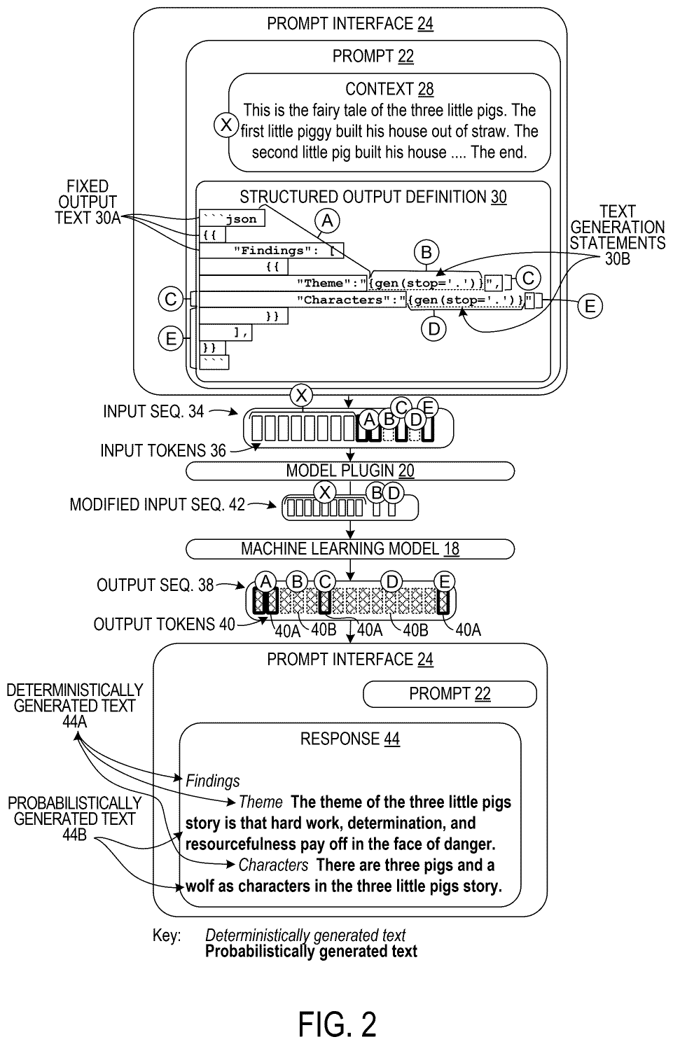

During inference, a prompt 22 is received via a prompt interface 24. The prompt interface 24 can be a graphical user interface of a program such as a chatbot, browser, or productivity application, in one set of examples, or an application programming interface, in another example. The prompt 22 is made up of text data, which can include unstructured text such as natural language input, and can also include structured text that can be interpreted by a preprocessor 26 in the model plugin 20. The prompt 22 includes context 28, which is unstructured text, typically in the form of natural language input (also referred to as unstructured natural language text). The context 28 may include information such as text from a source document, as well as data relating to how the prompt should be answered, such as an intended author, audience, style, length, and language of the desired response, and one or more instructions for the machine learning model 18. In the example discussed herein, the context 28 includes text of the Three Little Pigs fairy tale. The prompt 22 also includes a structured output definition 30. The structured output definition 30 is structured data that defines the structure of the machine learning model output (structured output 46), and is interpreted by the preprocessor 26 of the machine learning model 18, described below. The structured output definition 30 can be defined by a programming language, markup language, domain specific language, context free grammar, regular expression, schema, mathematical notation, or chemical formula, for example. In the illustrated examples of FIGS. 2-4, the structured output definition 30 is a Python code example of JavaScript Object Notation (JSON) encoding. Other programming languages and markup languages such as Java, C#, C/C++, RUST, R, HTML, etc. may alternatively be used. As shown in FIGS. 2-4 described below, the structured output definition 30 can include fixed output text 30A interleaved with text generation statements 30B.

Continuing with FIG. 1, the prompt 22, which is received in text format from the prompt interface 24, is tokenized by a tokenizer 32, and converted to an input sequence 34 of input tokens 36. The input sequence 34 thus includes the tokenized context 28 and tokenized structured output definition 30. It will be appreciated that the number of input tokens 34 in the input sequence is abbreviated for ease of illustration, and that in actuality a large number of tokens will be used. Thus, where one deterministic token is shown, one or multiple deterministic tokens are represented. A modified input sequence 42 and output sequence 38, described below, are similarly illustrated in a simplified manner and it will be appreciated that the actual number of tokens will vary.

The model plugin 20, during inference, is configured to receive the input sequence 34 of input tokens 36 of the prompt 22, and identify, via the preprocessor 26, one or more deterministic tokens 36A in the input tokens 36 corresponding to the structured output definition 30, as illustrated at decision block 26A. “Deterministic input tokens” as used herein refers to input tokens that are directly written to the output sequence 38 according to program logic in a deterministic manner, rather than based on probabilistic inference. What is deterministic about the deterministic input token 36A, therefore, is that it will appear in the output sequence 38 with certainty if designated as a deterministic input token 36A in the input sequence 36. Although rule-based approaches are envisioned for deciding whether an input token 36 is a deterministic input token 36A at decision block 26A, nothing herein precludes the deterministic input token 36A from being designated as a deterministic input token 36A using models that are probabilistic to make the decision at decision block 26A. Even if such probabilistic models are used, it does not change the certainty of inclusion of the deterministic input tokens 36A in the output sequence once designated. For example, fixed output text 30A (see FIGS. 2-4) that appears in the structured output definition 30 can be tokenized into corresponding deterministic input tokens 36A. Examples of fixed output text 30A are given in FIGS. 2-4 below. The other remaining input tokens 36B in the prompt correspond to the tokenization of the unstructured text that forms context 28 and to tokenization of text generation statements 30B (see FIGS. 2-4) in the structured output definition 30 (illustrated by dashed tokens 36B). Examples of text generation statements 30B are also given in FIGS. 2-4 below.

Continuing with FIG. 1, in response to identifying the one or more deterministic input tokens 36A (Y at 26A), the model plugin 20 is configured to skip transmission of the one or more deterministic input tokens 36A to the machine learning model 18 (i.e., to an input of a transformer 18A), and write the one or more deterministic input tokens 36A as deterministic output tokens 40A to an output token sequence 38 of output tokens 40. Skipping transmission of the deterministic input tokens 36A can be performed by the preprocessor 26 by masking or omitting the deterministic input token 36A in a modified input sequence 42 that is transmitted to an input of the transformer 18A of the machine learning model 18.

Further, the preprocessor 26 of the model plugin 20 is configured to pass a remainder of the input tokens 36B in the input sequence 26 other than the deterministic tokens 36A (i.e., pass the modified input sequence 42), to the machine learning model 18, as illustrated at decision block 26B at Y, where it is shown that the preprocessor 26 calls the machine learning model 18. The remainder of input tokens 36B includes probabilistic input tokens, as explained below. When the model plugin 20 is incorporated into the machine learning model 18, the step of skipping transmission can be performed by skipping transmission of the one or more deterministic tokens to an input of a transformer 18A of the machine learning model itself. After writing the one or more deterministic input tokens 36A as a deterministic output token 40A to the output token sequence 38 of output tokens 40, the model plugin 20 will update the transformer 18A, for example by updating a key value (KV) cache of the transformer 18A with the updated state of the output sequence 38, so that autoregressive generation passes in the transformer 18A can reference the updated state of the output sequence 38. Since autoregressive generation includes token-wise consideration of the output of the machine learning model 18 on each generation pass, the skipped tokens that were directly written to the output can still be considered during autoregressive generation, even though they are not included as input to the input layers of the machine learning model 18.

The machine learning model 18 is configured to perform probabilistic token-wise generation of other output tokens 40B besides deterministic output tokens 40A (which are deterministic input tokens 36A written to the output sequence 38) in the output sequence 38 based on the remainder of the input tokens 36B in the modified input sequence 42 without the one or more deterministic input tokens 36A.

As briefly mentioned above, the machine learning model 18 includes a transformer 18A. Transformer 18A is configured to token-wise generate the output sequence 38 of output tokens 40 based on the modified input sequence 42 and an autoregressive consideration of each prior output token in the output sequence 38 under token-wise generation. At each loop through the probabilistic generation loop depicted in FIG. 1, the transformer is configured to generate a probability distribution 18B of next tokens, ranked in probability order. A sampling algorithm is used to sample one of the tokens from the probability distribution 18B, as the next token for the output sequence 38. The sampling algorithm includes one or more sampling parameters that are used during selection of the output tokens 40 from the probability distribution 18B. As one example of a sampling parameter, a temperature hyperparameter may be adjusted to allow the sampling algorithm to exercise more “creativity” in its choices, by not always choosing the highest probability token, for example.

The machine learning model 18 is configured to output the output sequence 38 including a plurality of output tokens 40. The output tokens 40 include deterministic output tokens 40A directly written to the output sequence 38, and the probabilistic output tokens 40B generated by the probabilistic token-wise generation of the machine learning model 18. Once the generation of output tokens 40 has completed, the processing circuitry 12 is configured to convert, via tokenizer 32, the output sequence 38 into a response 44 including deterministically generated text 44A based on the deterministic output tokens 40A interleaved with probabilistically generated text 44B based on the probabilistic output tokens 40B.

It will be appreciated that “deterministic tokens” as used herein refer to tokens that are directly written from the input sequence to the output sequence in a deterministic manner with certainty of inclusion in the output sequence. Deterministic tokens can be contrasted with “probabilistic tokens,” which refer to tokens that are generated by computation that expresses outputs with a degree of confidence or probability that is less than guaranteed (100%) accuracy, such as the inference-time text generation performed by machine learning model 18. Thus, tokens generated by the machine learning model 18 are probabilistically generated output tokens 40B. Similarly, deterministically generated text 44A is text that is deterministically generated based on the identification of deterministic input tokens 36A in the input sequence by the preprocessor 26 and directly writing those as deterministic output tokens 40A to the output sequence 38, whereas probabilistically generated text 44B is text that is generated through probabilistic inference via machine learning model 18.

The processing circuitry 12 via the preprocessor 26 is configured to output deterministic token metadata labeling the deterministic output tokens 40A and/or probabilistic token metadata labeling the probabilistically generated output tokens 40B in the output sequence 38. Using this metadata, as shown in FIG. 2, the processing circuitry 12 is configured to display the deterministic output tokens 40A as deterministically generated text 44A in a visually distinguishable manner from the probabilistically generated text 44B based on probabilistically generated tokens 40B using the deterministic token metadata and/or probabilistic token metadata. In FIG. 2, the deterministically generated text 44A is shown in italics, while the probabilistically generated text 44B is shown in bold, although other visually distinguishable display options are contemplated, such as different colors, emphasis (underline, etc.), capitalization, highlighting, text boxes, size, fonts, etc.

The preprocessor 26 of the model plugin 20 is configured to parse the tokenized structured output definition 30 and sequentially process the interleaved fixed output text 30A and text generation statements 30B, to thereby interleave the deterministic output tokens 40A for the fixed output text 30A and probabilistically generated output tokens 40B generated in response to the text generation statements 30B, in the output sequence 38. Processing the fixed output text 30A is accomplished at least in part by the writing of the one or more deterministic output tokens 40A to the output sequence 38, and processing the text generation statement 30B is accomplished by passing the remainder of input tokens 36B to the machine learning model 18, where the remainder includes input tokens for the context 28 and at least one, and in some implementations multiple, text generation statements 30B.

This sequential processing is illustrated at (A) through (E) in FIG. 2. The tokenized text for sections (A), (C), and (E) in the input sequence and output sequence respectively include deterministic input tokens and deterministic output tokens representing corresponding continuous sequences of fixed output text, while the tokenized text for sections (B) and (D) represents continuous segments of tokenized text for text generation statements 30B. The preprocessor 26 of the model plugin 20 is configured to parse the tokens in the tokenized text for the structured output definition 30, and identify each of these sections (A)-(E). To aid in identification of the fixed output text and the text generation statements, each may be labeled by respective preprocessor directives that are interpreted by the preprocessor 26. When constructing the modified input sequence 42 from input sequence 34, the model plugin 20 includes the tokenized input from the context 28 as shown at (X), and also includes the tokenized text generation statements at (B) and (D) from the structured output definition 30. However, the model plugin 20 filters out all of the deterministic input tokens 36A in (A), (C), and (E) in the structured output definition 30, when constructing the modified input sequence 42. After the modified input sequence 42 is generated, the model plugin 20 sequentially parses the structured output definition 30, identifies section (A), writes the deterministic input tokens 36A for section (A) to the output sequence as deterministic output tokens 40A, and skips, by omitting or masking, the deterministic input tokens 36A from (A) so that they are not included in the modified input sequence 42. Next, the model plugin 20 identifies the text generation statement 30B at (B), and processes the text generation statement 30B by executing it. In one implementation, the tokenized text generation statement 30B can be passed to the machine learning model 18 appended to the context in the output sequence 38, without other text generation statements 30B such as (D). In this way, the machine learning model 18 will token-wise generate text responsive to the text generation statement 30B in (B), which is inserted into the output sequence 38 sequentially after the deterministic output tokens 40A corresponding to section (A). Next, the model can continue to parse the structured output definition 30 and identify the deterministic input tokens 36A associated with fixed output text 30A of section (C), which are inserted into the output sequence 38 as deterministic output tokens 40A after the probabilistically generated tokens 40B for section (B). The model plugin 20 continues to parse the structured output definition 30 and identifies tokenized text generation statement 30B at section (D), sends a modified input sequence 42 including tokenized text for text generation statement 30B at section (D) along with tokenized context 28 at (X) to the machine learning model 18, which returns probabilistically generated output tokens 40B corresponding to section (D) to the model plugin 20, which in turn inserts these tokens 40B into the output sequence 38 after the deterministic output tokens 40A from section (C). Finally, the model plugin 20 continues to parse the structured output definition 30 and identifies deterministic input tokens 36A corresponding to fixed output text 30A in section (E) and directly writes these as deterministic output tokens 40A after the tokens for section D in the output sequence 38. Although in the example above the tokens for text generation statements 30B at sections (B) and (D) are generated in separate calls to the machine learning model, it will be appreciated that these texts can be generated in a single call with a modified input sequence 42 including the tokenized context 28 at (X), and input tokens for both text generation statements 30B at sections (B) and (D), and the resulting probabilistically generated tokens 40B can be interleaved appropriately between deterministic output tokens 40A in the output sequence 38. If desired, generative text start and end tokens may be used in the output sequence 38 to indicate the start and end of each section of probabilistically generated tokens 40B. Similarly, fixed output text start and end tokens may be used in the output sequence 38 to indicate the start and end of each section of deterministic output tokens 40A. It will be appreciated that deterministic output tokens 40A and deterministic input tokens 36A refer to the same deterministic tokens, in different sequences (output sequence vs. input sequence).

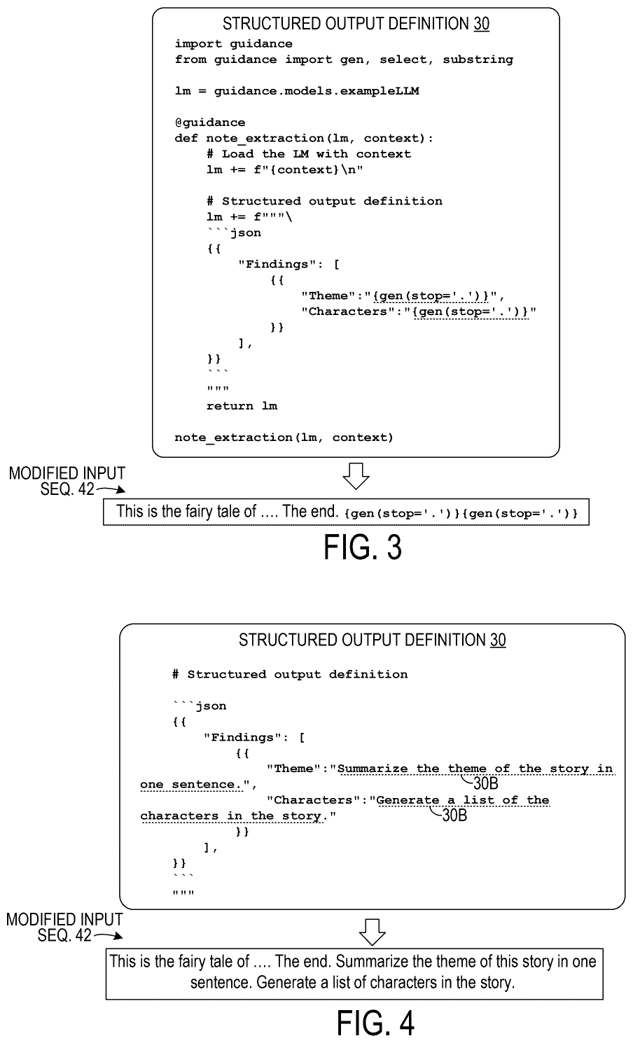

FIG. 3 shows the entire structured output definition 30 that is partially depicted in FIG. 2, as well as a schematic representation of the modified input sequence 42 generated based thereon, with text instead of tokenized text for ease of illustration. As shown in FIG. 3, input tokens 36 for the entire context 28 appear in the modified input sequence 42, as well input tokens 36 for the generative text statements in sections (B) and (D).

FIG. 4 illustrates an alternative example of structured output definition 30, including natural language examples of the text generation statements 30B. The modified input sequence 42 of FIG. 4 includes tokenized representations of context 28 and each of the natural language text generation statements 30B.

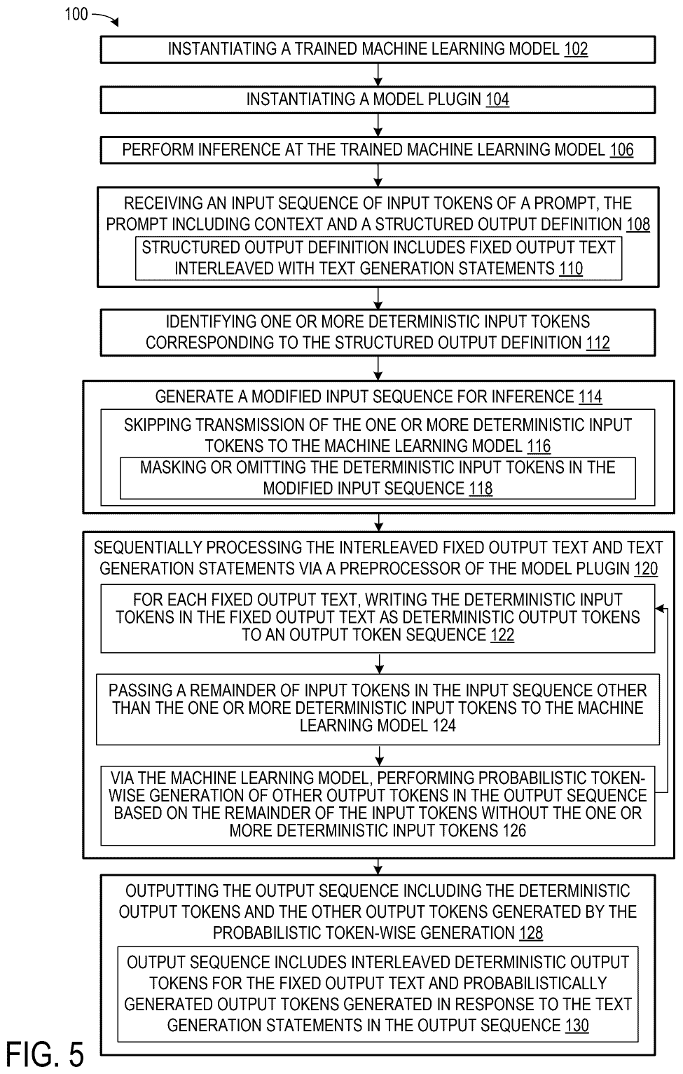

FIG. 5 illustrates a computerized method 100 according to one implementation of the present disclosure. Method 100 may be implemented using the computer software and hardware components described above, or other suitable computer hardware and software components. At 102, method 100 includes instantiating a trained machine learning model. At 104, the method includes instantiating a model plugin configured to interface with the machine learning model. At 106, the method includes performing inference at the trained machine learning model. During inference by the trained machine learning model, steps 108-128 may be performed.

At 108, the method includes receiving an input sequence of input tokens of a prompt, the prompt including context and a structured output definition. As discussed above, the structured output definition can be defined by, for example, a programming language, markup language, domain specific language, context free grammar, regular expression, schema, mathematical notation, or chemical formula. In one specific example, the machine learning model can be a generative language model, and the context can include unstructured natural language text. As shown at 110, the structured output definition can include fixed output text interleaved with text generation statements.

At 112, the method includes identifying one or more deterministic input tokens corresponding to the structured output definition. At 114, in response to identifying the one or more deterministic input tokens, the method includes generating a modified input sequence for inference by the machine learning model. As shown at 116, generating the modified input sequence can be accomplished by skipping transmission of the one or more deterministic input tokens to the machine learning model. As shown at 118, skipping transmission of the one or more deterministic input tokens can be performed by masking or omitting the token in the modified input sequence that is transmitted to the machine learning model.

As shown at 120, in some implementations, the method includes sequentially processing the interleaved fixed output text and fixed generation statements via a preprocessor of the model plugin, by looping through steps 122-126. Typically step 122 is performed for a sequence of deterministic input tokens corresponding to a unit of fixed output text, while each of step 124 and step 126 is performed for input tokens associated with a text generation statement in the structured output definition, and the loop through steps 122-126 continues until all tokens in the structured output definition have been parsed. At 122, the method includes writing each of the one or more deterministic input tokens as deterministic output tokens to an output token sequence. At 124, the method includes passing a remainder of input tokens in the input sequence other than the one or more deterministic input tokens to the machine learning model. At 126, the method includes, via the machine learning model, performing probabilistic token-wise generation of other output tokens in the output sequence based on the remainder of the input tokens without the one or more deterministic input tokens.

Processing the fixed output text can be accomplished at least in part by the writing the one or more deterministic input tokens as deterministic output tokens to the output sequence. Further, processing the text generation statement can be accomplished at least in part by passing the remainder of input tokens to the machine learning model, where the remainder includes input tokens for the context and at least one text generation statement.

At 128, the method includes outputting the output sequence including the deterministic output tokens and the other output tokens generated by the probabilistic token-wise generation. As shown at 130, as a result of the step of sequentially processing, the deterministic output tokens for the fixed output text and probabilistically generated output tokens generated in response to the text generation statements in the output sequence are thereby interleaved in the output sequence. The method can further include converting, via a tokenizer, the output sequence into a response including deterministically generated text based on the deterministic output tokens interleaved with probabilistically generated text based on the other output tokens.

The above-described systems and methods offer the technical advantage of reducing calls to the machine learning model due to skipping of deterministic input tokens. Reducing the number of calls to the machine learning model saves computational resources, energy, and time. Another technical advantage of the above-described systems and methods is that by defining the structured output definition and generating interleaved deterministic and probabilistic tokens, the generative power of machine learning models can be harnessed in a way that increases the accuracy and stability of the resulting output, by controlling the structure of the output. The creativity of such models can be fully utilized when needed, but kept harnessed to the structured output specifications for a particular software system.

In some embodiments, the methods and processes described herein may be tied to a computing system of one or more computing devices. In particular, such methods and processes may be implemented as a computer-application program or service, an application-programming interface (API), a library, and/or other computer-program product.

The methods and processes described herein are tied to a computing system of one or more computing devices. In particular, such methods and processes can be implemented as a computer-application program or service, an application-programming interface (API), a library, and/or other computer-program product.

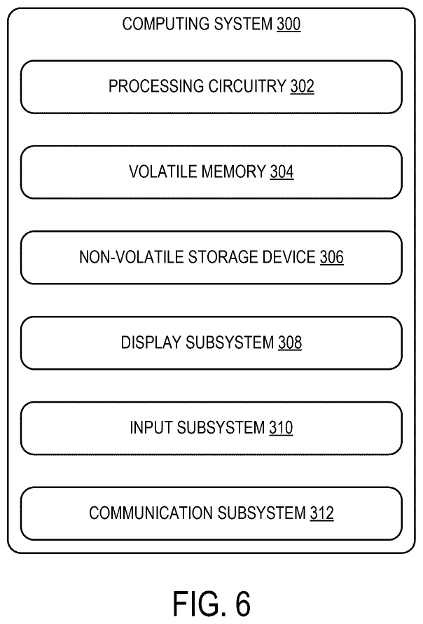

FIG. 6 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, comprising processing circuitry and associated memory storing instructions that when executed cause the processing circuitry to instantiate a trained machine learning model. The instructions further cause the processing circuitry to instantiate a model plugin that, during inference, is configured to receive an input sequence of input tokens of a prompt, the prompt including context and a structured output definition. The instructions further cause the processing circuitry to identify one or more deterministic input tokens corresponding to the structured output definition. The instructions further cause the processing circuitry to, in response to identifying the one or more deterministic input tokens, skip transmission of the one or more deterministic input tokens to the machine learning model and write the one or more deterministic input tokens as one or more deterministic output tokens to an output token sequence. The instructions further cause the processing circuitry to pass a remainder of input tokens in the input sequence other than the one or more deterministic input tokens to the machine learning model. Via the machine learning model, the instructions further cause the processing circuitry to perform probabilistic token-wise generation of other output tokens in the output sequence based on the remainder of the input tokens without the one or more deterministic input tokens. The instructions further cause the processing circuitry to output the output sequence including the one or more deterministic output tokens and the other output tokens generated by the probabilistic token-wise generation.

According to this aspect, the machine learning model may be a generative language model and the context may include unstructured natural language text.

According to this aspect, the structured output definition may include fixed output text interleaved with text generation statements.

According to this aspect, a preprocessor of the model plugin may be configured to sequentially process the interleaved fixed output text and text generation statements, to thereby interleave the one or more deterministic output tokens for the fixed output text and probabilistically generated output tokens generated in response to the text generation statements in the output sequence.

According to this aspect, processing the fixed output text may be accomplished at least in part by the writing of the one or more deterministic output tokens to the output sequence. Processing the text generation statement may be accomplished by passing the remainder of input tokens to the machine learning model. The remainder may include input tokens for the context and the text generation statement.

According to this aspect, fixed output text and the text generation statements may be labeled by respective preprocessor directives that are interpreted by the preprocessor.

According to this aspect, skipping transmission of the one or more deterministic input tokens may be performed by masking or omitting each deterministic input token in a modified input sequence that is transmitted to the machine learning model.

According to this aspect, the processing circuitry may be configured to convert, via a tokenizer, the output sequence into a response including deterministically generated text based on the one or more deterministic output tokens interleaved with probabilistically generated text based on the other output tokens.

According to this aspect, the structured output definition may be defined by a programming language, markup language, domain specific language, context free grammar, regular expression, schema, mathematical notation, or chemical formula.

According to this aspect, the processing circuitry may be configured to output deterministic token metadata labeling the deterministic input tokens in the output sequence and/or probabilistic token metadata labeling the other tokens in the output sequence generated by the machine learning model. The processing circuitry may be further configured to display deterministically generated text based on the one or more deterministic output tokens in a visually distinguishable manner from probabilistically generated text based on the other tokens using the deterministic token metadata and/or probabilistic token metadata.

According to this aspect, the machine learning model may be a transformer-based model including an encoder-decoder architecture, decoder-only architecture, or encoder-only architecture.

According to another aspect of the present disclosure, a computerized method is provided, including instantiating a trained machine learning model. The method further includes instantiating a model plugin. During inference by the trained machine learning model, the method further includes receiving an input sequence of input tokens of a prompt, the prompt including context and a structured output definition. The method further includes identifying one or more deterministic input tokens corresponding to the structured output definition. In response to identifying the one or more deterministic input tokens, the method further includes skipping transmission of the one or more input deterministic tokens to the machine learning model and writing the one or more deterministic input tokens as one or more deterministic output tokens to an output token sequence. The method further includes passing a remainder of input tokens in the input sequence other than the one or more deterministic input tokens to the machine learning model. Via the machine learning model, the method further includes performing probabilistic token-wise generation of other output tokens in the output sequence based on the remainder of the input tokens without the one or more deterministic input tokens. The method further includes outputting the output sequence including the one or more deterministic output tokens and the other output tokens generated by the probabilistic token-wise generation.

According to this aspect, the machine learning model may be a generative language model and the context may include unstructured natural language text.

According to this aspect, the structured output definition may include fixed output text interleaved with text generation statements.

According to this aspect, the method may further include sequentially processing the interleaved fixed output text and text generation statements via a preprocessor of the model plugin, to thereby interleave the one or more deterministic output tokens for the fixed output text and the other output tokens, the other output tokens including probabilistically generated output tokens generated in response to the text generation statements in the output sequence.

According to this aspect, processing the fixed output text may be accomplished at least in part by the writing of the one or more deterministic output tokens to the output sequence. Processing the text generation statements may be accomplished by passing the remainder of input tokens to the machine learning model. The remainder may include input tokens for the context and the text generation statements.

According to this aspect, skipping transmission of the one or more deterministic input tokens may be performed by masking or omitting the one or more deterministic input tokens in a modified input sequence that is transmitted to the machine learning model.

According to this aspect, the method may further include converting, via a tokenizer, the output sequence into a response including deterministically generated text based on the deterministic output tokens interleaved with probabilistically generated text based on the other output tokens.

According to this aspect, the structured output definition may be defined by a programming language, markup language, domain specific language, context free grammar, regular expression, schema, mathematical notation, or chemical formula.

According to another aspect of the present disclosure, a computing system is provided, including processing circuitry and associated memory storing instructions that when executed cause the processing circuitry to instantiate a trained machine learning model. The trained machine learning model is configured to receive an input sequence of input tokens of a prompt. The prompt includes context and a structured output definition. The trained machine learning model is further configured to identify one or more deterministic input tokens corresponding to the structured output definition. In response to identifying the one or more deterministic input tokens, the trained machine learning model is further configured to skip transmission of the one or more deterministic input tokens to an input of a transformer of the machine learning model and write the one or more deterministic input tokens as one or more deterministic output tokens to an output token sequence. The trained machine learning model is further configured to perform probabilistic token-wise generation of other output tokens in the output sequence based on a remainder of the input tokens without the one or more deterministic input tokens. The instructions further cause the processing circuitry to output the output sequence including the one or more deterministic output tokens and the other output tokens generated by the probabilistic token-wise generation.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and associated memory storing instructions that when executed cause the processing circuitry to:
instantiate a trained machine learning model;
instantiate a model plugin that, during inference, is configured to:
receive an input sequence of input tokens of a prompt, the prompt including context and a structured output definition;
identify one or more deterministic input tokens corresponding to the structured output definition;
in response to identifying the one or more deterministic input tokens:
skip transmission of the one or more deterministic input tokens to the machine learning model; and
write the one or more deterministic input tokens as one or more deterministic output tokens to an output token sequence;
pass a remainder of input tokens in the input sequence other than the one or more deterministic input tokens to the machine learning model;
via the machine learning model, perform probabilistic token-wise generation of other output tokens in the output sequence based on the remainder of the input tokens without the one or more deterministic input tokens; and
output the output sequence including the one or more deterministic output tokens and the other output tokens generated by the probabilistic token-wise generation.

2. The computing system of claim 1, wherein
the machine learning model is a generative language model; and
the context includes unstructured natural language text.

3. The computing system of claim 1, wherein the structured output definition includes fixed output text interleaved with text generation statements.

4. The computing system of claim 3, wherein a preprocessor of the model plugin is configured to sequentially process the interleaved fixed output text and text generation statements, to thereby interleave the deterministic output tokens for the fixed output text and the other output tokens, the other output tokens including probabilistically generated output tokens generated in response to the text generation statements in the output sequence.

5. The computing system of claim 4, wherein
processing the fixed output text is accomplished at least in part by the writing of the one or more deterministic output tokens to the output sequence; and
processing the text generation statements is accomplished by passing the remainder of input tokens to the machine learning model, where the remainder includes input tokens for the context and the text generation statements.

6. The computing system of claim 4, wherein fixed output text and the text generation statements are labeled by respective preprocessor directives that are interpreted by the preprocessor.

7. The computing system of claim 1, wherein skipping transmission of the one or more deterministic input tokens is performed by masking or omitting the one or more deterministic input tokens in a modified input sequence that is transmitted to the machine learning model.

8. The computing system of claim 1, wherein the processing circuitry is configured to convert, via a tokenizer, the output sequence into a response including deterministically generated text based on the deterministic output tokens interleaved with probabilistically generated text based on the other output tokens.

9. The computing system of claim 1, wherein the structured output definition is defined by a programming language, markup language, domain specific language, context free grammar, regular expression, schema, mathematical notation, or chemical formula.

10. The computing system of claim 1, wherein the processing circuitry is configured to:
output deterministic token metadata labeling the one or more deterministic output tokens in the output sequence and/or probabilistic token metadata labeling the other tokens in the output sequence generated by the machine learning model; and
display deterministically generated text based on the one or more deterministic output tokens in a visually distinguishable manner from probabilistically generated text based on the other tokens using the deterministic token metadata and/or probabilistic token metadata.

11. The computing system of claim 1, wherein the machine learning model is a transformer-based model including an encoder-decoder architecture, decoder-only architecture, or encoder-only architecture.

12. A computerized method, comprising:
instantiating a trained machine learning model;
instantiating a model plugin;
during inference by the trained machine learning model:
receiving an input sequence of input tokens of a prompt, the prompt including context and a structured output definition;
identifying one or more deterministic input tokens corresponding to the structured output definition;
in response to identifying the one or more deterministic input tokens:
skipping transmission of the one or more deterministic input tokens to the machine learning model; and
writing the one or more deterministic input tokens as one or more deterministic output tokens to an output token sequence;
passing a remainder of input tokens in the input sequence other than the one or more deterministic input tokens to the machine learning model;
via the machine learning model, performing probabilistic token-wise generation of other output tokens in the output sequence based on the remainder of the input tokens without the one or more deterministic input tokens; and
outputting the output sequence including the one or more deterministic output tokens and the other output tokens generated by the probabilistic token-wise generation.

13. The computerized method of claim 12, wherein
the machine learning model is a generative language model; and
the context includes unstructured natural language text.

14. The computerized method of claim 12, wherein the structured output definition includes fixed output text interleaved with text generation statements.

15. The computerized method of claim 14, further comprising:
sequentially processing the interleaved fixed output text and text generation statements via a preprocessor of the model plugin, to thereby interleave the deterministic output tokens for the fixed output text and probabilistically generated output tokens generated in response to the text generation statements in the output sequence.

16. The computerized method of claim 15, wherein
processing the fixed output text is accomplished at least in part by the writing of the one or more deterministic output tokens to the output sequence; and
processing the text generation statements is accomplished by passing the remainder of input tokens to the machine learning model, where the remainder includes input tokens for the context and the text generation statements.

17. The computerized method of claim 12, wherein skipping transmission of the one or more deterministic input tokens is performed by masking or omitting the one or more deterministic input tokens in a modified input sequence that is transmitted to the machine learning model.

18. The computerized method of claim 12, further comprising:
converting, via a tokenizer, the output sequence into a response including deterministically generated text based on the deterministic output tokens interleaved with probabilistically generated text based on the other output tokens.

19. The computerized method of claim 12, wherein the structured output definition is defined by a programming language, markup language, domain specific language, context free grammar, regular expression, schema, mathematical notation, or chemical formula.

20. A computing system, comprising:
processing circuitry and associated memory storing instructions that when executed cause the processing circuitry to:
instantiate a trained machine learning model, configured to:
receive an input sequence of input tokens of a prompt, the prompt including context and a structured output definition;
identify one or more deterministic input tokens corresponding to the structured output definition;
in response to identifying the one or more deterministic input tokens:
skip transmission of the one or more deterministic input tokens to an input of a transformer of the machine learning model; and
write the one or more deterministic input tokens as deterministic output tokens to an output token sequence;
perform probabilistic token-wise generation of other output tokens in the output sequence based on a remainder of the input tokens without the one or more deterministic input tokens; and
output the output sequence including the deterministic output tokens and the other output tokens generated by the probabilistic token-wise generation.
